(19) United States
(12) Patent Application Publication
(10) Pub. No.: US 2024/0127572 A1
(43) Pub. Date: Apr. 18, 2024

(54) REAL-TIME OCCLUSION DETECTION BETWEEN FRAMES FOR VIDEO STREAMING SYSTEMS AND APPLICATIONS

(71) Applicant: Nvidia Corporation, Santa Clara, CA (US)

(72) Inventors: Karthick Sekkappan, Pune (IN); Aurobinda Maharana, Chinchwad (IN)

(21) Appl. No.: 17/968,260

(22) Filed: Oct. 18, 2022

(51) Int. Cl. G06V 10/26; G06T 7/269; G06V 10/56; G06V 10/60; H04N 19/139

(52) U.S. Cl. CPC G06V 10/26; G06T 7/269; G06V 10/56; G06V 10/60; H04N 19/139; G06T 2207/10016; G06T 2207/20032

(57) ABSTRACT

Systems and methods estimate occluded pixels in frames of a video sequence. Optical flow data is received to determine a validity for forward and backward flow vectors for a common pixel location in a first frame and a second frame that are temporally next to one another. Occlusion information for the first frame determines pixels that are hidden in the second frame with respect to playback from the first frame to the second frame. Occlusion information for the second frame determines pixels that are hidden in the first frame with respect to playback from the second frame to the first frame.

### BACKGROUND

Video sequences may include foreground and background objects where movement of the foreground or background objects can lead to occlusion of pixels between frames in video sequences. Conventional techniques for detecting occluded pixels based on their flow vectors may not always be able to distinguish between occlusion and noise, and as a result, may generate unacceptable results. By extension, existing approaches that utilize these techniques for detecting occluded pixels may fail based on insufficient and noisy input flow information. Methods to address these problems are often inaccurate, time consuming, or resource intensive.

### BRIEF DESCRIPTION OF THE DRAWINGS

Various embodiments in accordance with the present disclosure will be described with reference to the drawings, in which:

FIG. 1 illustrates an example of an environment for video segment processing, according to at least one embodiment;

FIGS. 2A and 2B illustrate example representations of occlusion due to movement of a foreground object, according to at least one embodiment;

FIGS. 3A and 3B illustrate example representations of movement of objects between a first image frame and a second image frame, according to at least one embodiment;

FIG. 4 illustrates an example representation of identified occlude regions in a frame, according to at least one embodiment;

FIG. 5 illustrates an example flow chart of a process for determining occluded regions in an image based on optical flow data, according to at least one embodiment;

FIG. 6A illustrates an example flow chart of a process for determining an occlusion status for pixels in an image, according to at least one embodiment;

FIG. 6B illustrates an example flow chart of a process for generating an occlusion output, according to at least one embodiment;

FIG. 6C illustrates an example flow chart of a process for generating an occlusion output, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

Approaches in accordance with various embodiments overcome deficiencies of convention techniques—such as those described above—by providing a lightweight, fast, real time or near-real time (e.g., without significant delay) method to detect occluded pixels between frames of a video sequence. In at least one embodiment, occluded pixels correspond to pixels in a previous frame that are occluded in a current frame. Occlusion may be determined using optical flow data (e.g., motion vectors) that may be noisy and/or inaccurate. Various embodiments may use one or more methods to determine inaccurate flow vectors, such as a forward-backward check. Additionally, embodiments may incorporate one or more image properties to evaluate occlusion, such as evaluation of chroma (UV) to differentiate between shadow and non-shadow regions. Various embodiments may perform one or more passes over different pixels to identify occlusion between frames (e.g., occlusion in a second frame from a first frame). For example, logical deduction may be used to determine whether a flow vector is valid in both a forward direction and a backward direction. If not, the invalid flow vector may be used to determine where occlusion occurs. Additionally, a second pass may apply one or more filters to identify sparsely distributed inaccurate flow vectors, which may be indicative of noise. In this manner, a lightweight, easy to apply, occlusion detection pipeline may be implemented that can be used in real or near-real time (e.g., without significant delay), even with noisy optical flow data.

Embodiments of the present disclosure implement a two-pass approach in addition to a forward-back check in order to identify occluded regions between two frames. For example, a forward-backward check may evaluate respective validities of flow vectors (e.g., motion vectors) for a common pixel between two frames. The determined respective flow validities may then be used to identify, for occluded pixels, where the occlusion occurs (e.g., in a first frame or a second frame). Furthermore, embodiments may provide improvements over methods that use luma (Y) for comparisons, which may inadvertently invalidate flow vectors that transition into a shadow region, by comparing chroma (UV) values. Furthermore, various embodiments provide improvements over prior art methods that require accurate optical flow data, which may be difficult or expensive to obtain, and often makes previous methods ineffective for real or near-real time processing. Additionally, embodiments of the present disclosure may identify occluded regions without the use of depth data, which may provide a wider range of applications because many types of input video data may not have a Z-buffer to incorporate depth data.

Embodiments provide the ability to perform occlusion detection with noisy optical flow data, using a variety of different engines to determine optical flow information, and with a lighter model than existing methods. A pair of temporally spaced images (e.g., subsequent frames within a video) are analyzed so that forward and backward flow vectors for each pixel are determined. For each pixel within the images, the flow vectors may be evaluated to determine whether or not they are valid, with a valid flow vector being a flow vector where a pixel moves from a first position to a second position (forward) and from a second position to a first position (backward). If the flow vector is invalid for a position (x,y) in forward flow, and if the flow vector is valid for the same position (x,y) in backward flow, then the pixel in the first frame is identified as a pixel that is occluded in the second frame. Embodiments may also deploy a filtering process in order to identify wrongly identified pixels, for example pixels that were wrongly identified due to noise. The result may be an indication of occluded pixels between two images, which may be used for a variety of applications, such as frame interpolation, motion tracking, and the like.

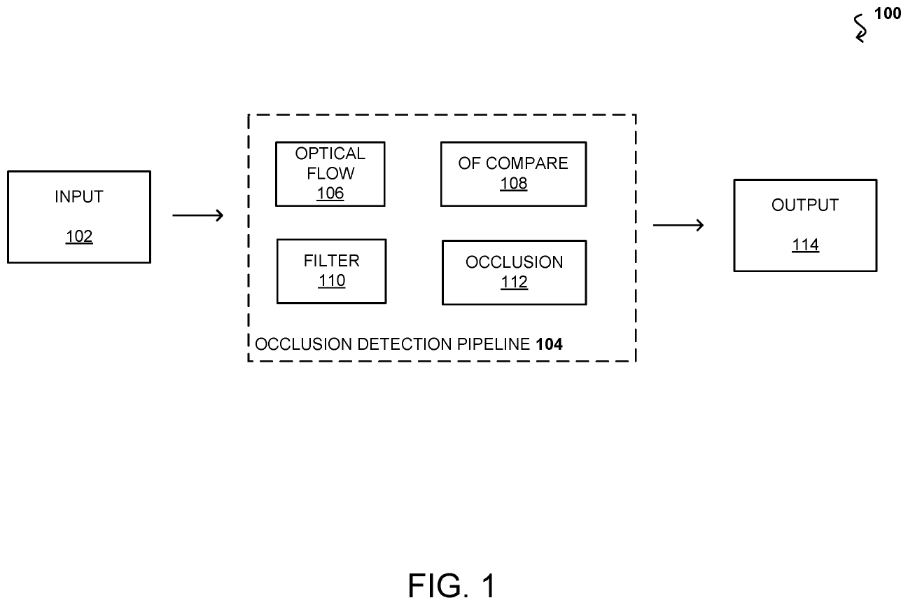

FIG. 1 illustrates an example environment 100 that can be used to provide such functionality in accordance with at least one embodiment. In this example, the environment may be associated with one or more video processing systems, such as a game engine, a motion detection system, a navigation system, or the like. As shown, an input 102 is provided to an occlusion detection pipeline 104. The input 102 may include image data, such as a video sequence, that includes a series of frames of image data. The input 102 may be provided from an optical capture device, such as a video recorder, where the input 102 may be a live video feed, a stored video file, a generated video image, or some combination thereof. The input may also be part of gameplay footage, such as footage produced by a graphics processor by executing a video game. Additionally, the input 102 may be one or more images received from a game engine for rendering on a display, which may be responsive to one or more actions input by a user.

In various embodiments, the input 102 includes at least two frames, where the frames may be temporally close in time to one another. The frames may be sequential, but it should be appreciated that various embodiments may use non-sequential frames. While, using frames with greater time differences between them may lead to less accurate detection due to the potential for more movement over time, embodiments of the present disclosure are adapted to identify occluded regions (e.g., pixels of a frame that get occluded or hidden in a next frame due to motion) within a frame even with larger spacing between frames.

An occlusion detection pipeline 104 is shown to receive and process the input 102 (e.g., the two or more frames). The occlusion detection pipeline 104 is shown by way of example and may include more or fewer components or modules, which may correspond to one or more processing units and one or more memories that may execute stored code in the form of algorithms to perform one or more tasks. In this non-limiting example, the occlusion detection pipeline 104 includes an optical flow engine 106, a comparison unit 108, a filter 110, and an occlusion detector 112. As will be appreciated, one or more of these components may be integrated into another, and/or within the same software package, and are shown as separated components for clarity with the present disclosure. Furthermore, it should be appreciated that one or more components may be in communication with the occlusion detection pipeline 104 but not necessarily part of the pipeline 104. For example, the optical flow engine 106 may be a separate system that the occlusion detection pipeline 104 can communicate with in order to receive optical flow data.

The optical flow engine 106 may include one or more algorithms for determining optical flow between a pair of images, or in various embodiments, a larger sequence of images. The optical flow engine 106 may be used to determine one or both of a forward optical flow or a backward optical flow. A forward optical flow corresponds to movement between a first frame and a second frame where the first frame is at a first time to and a second frame is at a second time ti. A backward optical flow corresponds to movement between a second frame and a first frame, where the first frame is at a first time to and a second frame is at a second time ti. It should be appreciated that a variety of algorithms may be used to determine the optical flow, including but not limited the NVIDIA Optical Flow Software Development Kit (SDK) from NVIDIA Corporation.

In various embodiments, optical flow may refer to a motion vector corresponding to a pattern or trajectory of apparent motion of an object in a visual scene. The motion may be driven by movement of the object (e.g., a foreground object moving to cover a background object) or by movement of the frame/perspective of the frame itself, such as due to zooming or panning. As a result, the optical flow may be presented in the form of a vector starting at a first pixel and then extending toward a different, second pixel. For an image, optical flow may refer to a 2-dimensional vector field where each vector is a displacement vector showing movement of points from a first frame to a second frame. It should be appreciated that optical flow may be presented in both 2-dimensions and 3-dimensions, but various embodiments may describe optical flow with reference to a 2-dimensional vector for simplicity.

Various embodiments provide the input 102 to the optical flow engine 106 in order to estimate optical flow for pixels within the input image frames. In various embodiments, optical flow is estimated for each pixel. That is, a motion vector corresponding to estimated movement of each pixel is determined. While the optical flow may be output as a visualization, for example as the frame itself with an overlaid gradient showing vector direction or intensity, it should be appreciated that the optical flow corresponds to the specific vectors associated with the pixels. Furthermore, embodiments may selectively determine optical flow for certain pixels within images, but not for all pixels.

The comparison unit 108 may receive the estimated optical flow data in order to compare pixel flow vectors between the input image frames. In at least one embodiment, the comparison unit 108 may evaluate different optical flow vectors to determine whether or not the flow vectors are valid. As used herein, a valid flow vector may refer to a flow vector that indicates true motion of a pixel from one frame to another. This may include, by way of non-limiting example, a pixel associated with a moving object that occludes a background, but other flow vectors, such as those that do not occlude a background, may also be valid. In contrast, an invalid flow vector may refer to a flow vector associated with a pixel that is occluded in a next frame, such as by a moving object or due to changes in the view area of an image (e.g., panning, zooming, etc.). It should be appreciated that not all flow vectors generated by one or more optical flow algorithms are valid. For example, some are invalid due to noise in the algorithm and some may be invalid due to occlusion, in which case since the object is not present in next frame, the algorithm cannot find a correct flow vector for it. The comparison unit 108 may compare forward and backward flow vectors for pixels. For example, the optical flow engine 106 may provide information associated with forward flow (e.g., flow from a first frame to a later second frame) and backward flow (e.g., flow from a later second time to an earlier first frame). A forward-backward consistency check may be performed to determine whether forward and backward flows disagree by more than a threshold. Based, at least in part, on this consistency check, inaccurate flow vectors may be identified, where the inaccurate flow vectors point to pixels indicative of occluded pixels, as will be described below. The comparison unit 108 may perform such checks over the pixels within the input images in order to initially identify the inaccurate flow vectors that may correspond to occluded pixels. Additionally, the comparison unit 108 may also be used to perform one or more passes of a potentially multi-pass process to identify occluded pixels. For example, the comparison unit 108 may include logic to determine a validity status of different flow vectors for an associated pixel (x,y) between a first frame and a second frame, and determine where occlusion occurs.

It should be appreciated that various embodiments of the present disclosure may be used with noisy input optical flow data. That is, the output of the optical flow engine 106 may be noisy or may provide incomplete data. This may be the result of using a real or near-real time method, poor quality inputs to the optical flow engine 106, or a variety of other reasons. This noisy information may lead to wrongly identified invalid flow vectors, and as a result, to wrongly identified occluded pixels. Various embodiments may deploy the filter module 110 to run a filter on an estimated occlusion output from the comparison unit 108. In one example, a median filter is applied. Filtering may assist with identification of wrongly identified invalid flow vectors because inaccurate flow vectors due to occlusion tend to spatially congregate. In contrast, inaccurate flow vectors due to noise in flow vector data tends to be sparsely distributed in space. Accordingly, running a filter, such as a median filter, removes incorrect occlusion labels. This filter step may be performed as a second pass or second step after the initial comparison and identification using the forward-backward check and after further logical deduction processing. It should be appreciated that filtering is provided as an example and other methods, such as erosion or dilation may also be incorporated in addition to, or in place of, one or more filtering steps.

The occlusion detector 112 may be used to aggregate the results of the comparison unit 108 and the filter 110 in order to generate an output 114, which may correspond to data indicating which pixels are occluded in one or more frames. For example, the output 114 may identify one or more regions of occluded pixels in a frame. The output 114 may be provided as data that may be used by one or more downstream processes, such as a game engine, optical tracking system, navigation systems, video processor, or the like.

As noted above, a variety of methods may be used to determine optical flow and/or occluded pixels. For example, deep learning techniques, such as Recurrent All-Pairs Field Transforms (“RAFT”), may be used for optical flow estimation. However, these may suffer from accuracy problems and may not be suitable for real or near-real time operation. Other methods may try to estimate both occlusion and optical flow simultaneously or substantially simultaneously, but these methods may not be suitable where optical flow data is already estimated using one or more different techniques. Many of these methods are processor-intensive and not suitable for real or near-real time applications. This may be especially noticeable for use with game engines, which may be using a system GPU for rendering and, as a result, may not be able to allocate sufficient resources for neural network based occlusion detection. Various embodiments address these drawbacks by providing a light weight system that may be used in real or near-real time to identify occluded regions of images.

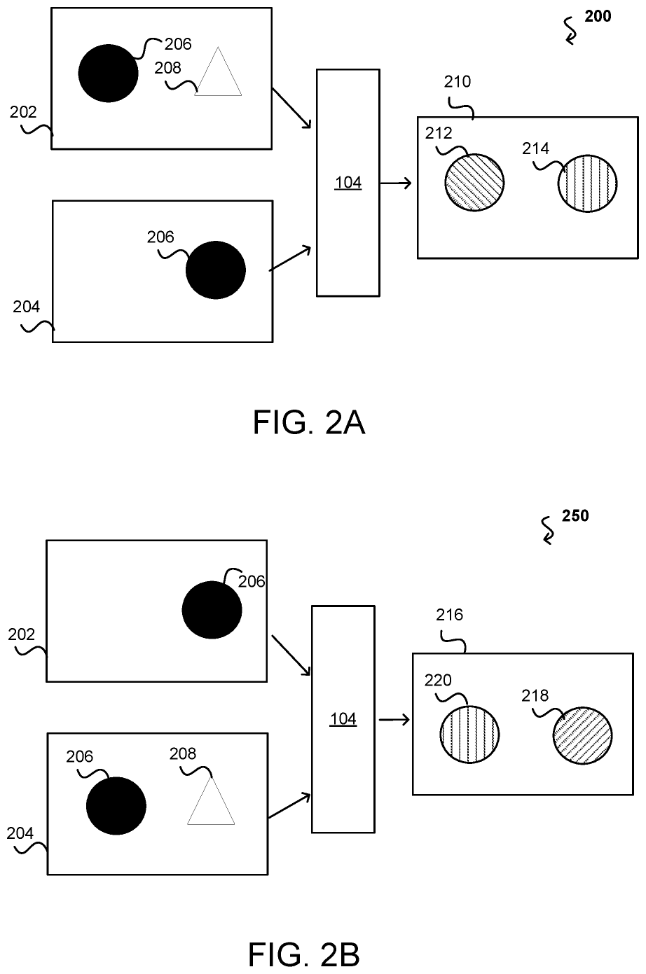

FIGS. 2A and 2B illustrate representations 200, 250 of an optical flow determination between a forward optical flow in the representation 200 and a backward optical flow in the representation 250. In the examples, frames 202, 204 are presented for evaluation by the occlusion detection pipeline 104. The frames 202, 204 may be part of a video sequence and may be temporally spaced frames, such that the frame 202 is at a first time and the frame 204 is at a second time, which in this example is later than the first time. In various embodiments, the frame 202 may be referred to as “Frame A” or “A” and the frame 204 may be referred to as “Frame B” or “B.” A first object 206 is shown in both frames 202, 204. The first object 206 is positioned at a pixel location (x,y) in the frame 202, which may be denoted as A₁(x,y) in FIG. 2A. A second object 208 is shown in the first frame 202 of FIG. 2A and the second frame 204 of FIG. 2B. The second object 208 is positioned at a pixel location (x, y) in the frame 202 of FIG. 2A, where the location may be donated at A₂(x,y).

Referring to FIG. 2A, the first object 206 moves from the pixel location A₁(x,y) in the first frame 202 to the pixel location A₂(x,y) in the second frame 204, thereby occluding the second object 208 in the second frame 204. The first object 206 is then shown positioned at the pixel location B₁(x,y) in the second frame 204, which may correspond to A₂(x,y), in certain embodiments. As a result, the second object 208 is no longer visible in the second frame 204 due to the movement of the first object 206. This movement may be processed by the occlusion detection pipeline 104, which may generate a representation 210 of these optical flows for the object 206. It should be appreciated that the representation 210 is for illustrative purposes and for clarity and that, in various embodiments, the output corresponding to optical flow is a vector associated with the different pixel locations. In this example, an optical flow representation 212 indicates a flow vector (Fₐ(x,y)) from pixel A₁(x,y) to an associated pixel in the second frame 204, B₁(x,y). The optical flow representation 212 is shown with different hatching from a second optical flow representation 214. The optical flow representation 212 is a valid flow vector that points to the right (e.g., indicates that the first object 206 has moved to the right between the first frame 202 and the second frame 204). The optical flow representation 214 is an invalid flow vector due to occlusion caused by the movement of the first object 206. It should be appreciated that optical flow vectors may also be invalid due to noise, but this representation is not shown in FIG. 2A.

Referring to FIG. 2B, the first object 206 moves from the pixel location A₂(x,y) to the pixel location A₁(x,y) between the first frame 202 and the second frame 204, thereby no longer occluding the second object 208. The first object 206, after the movement, is shown positioned at the pixel location B₁(x,y), which may correspond to A₁(x,y) in certain embodiments. Additionally, after the movement, the second object 208 is now visible at the pixel location A₂(x,y), which may also be referred to as B₁(x,y). This movement may be processed by the occlusion detection pipeline 104, which generates a representation 216 of these optical flows for the objects. It should be appreciated that the representation 216 is for illustrative purposes and for clarity and that, in various embodiments, the output is a vector associated with the different pixel locations. In this example, an optical flow representation 218 indicates a flow vector (F_{b}(x,y)) from pixel A₂(x,y) to an associated pixel in the second frame 204, B₂(x, y). The optical flow representation 218 is shown with different hatching from a second optical flow representation 220. The optical flow representation 218 is a valid flow vector that points to the left (e.g., indicates that the first object 206 has moved to the left between the first frame 202 and the second frame 204). The optical flow representation 220 is an invalid flow vector due occlusion caused by the movement of the first object 206.

As shown, movement of the objects in FIGS. 2A and 2B generates occluded areas in different frames 202, 204, which may not have a valid optical flow vector, and as a result, may not be used for a variety of applications without expensive analysis and inpainting. Identifying these occluded areas may be useful for a variety of applications, such as for game engines, video processing, object detection, navigation, and the like. Embodiments enable detection of occluded pixels using one or more systems or methods, which may include a two-step process to detect an occluded region given a pair of frames. In the following discussion, A corresponds to a frame in a video sequence and B corresponds to a frame temporally next to A, but not necessary the next frame in the sequence, as noted above. A(x, y) is a pixel located at an (x,y) coordinate in Frame A, F a (x,y) indicates a flow vector from pixel A(x,y) to a pixel in B (e.g., a forward direction flow vector), and F_{b}(x,y) indicates a flow vector from pixel B(x,y) to a pixel in A (e.g., a backward direction flow vector).

In an example first step of what may, in certain embodiments, be a multi-step process, a forward-backward check may be used to detect inaccurate flow vectors in the forward flow vector (F_{b}(x,y)) and the backward flow vector (F_{b}(x,y)). Additionally, embodiments may further account for scenarios where a valid flow vector shows movement from a shadow to a non-shadow region. Traditional approaches may evaluate the luma component of a pixel, and using only luma, these vectors may be incorrectly identified as invalid. Embodiments of the present disclosure additionally use chroma to overcome this limitation. For example, if a source pixel and a destination pixel have a difference in luma (e.g., more than a threshold), but similar chroma values (e.g., within a threshold), then the flow vector may be considered valid. The thresholds may be based, at least in part, on the content or scenario in which embodiments are used. For example, a video game may have different threshold tolerances than a motion tracking scenario for a self-driving vehicle or autonomous robot. Accordingly, thresholds may be adjusted based on information about the content associated with the input frames.

The forward-backward check may assist when detecting inconsistent flow vectors, but may be insufficient to determine whether a flow vector is invalid due to occlusion or due to noise. As a result, embodiments may further incorporate additional passes on one or more pixels of the input images. For example, a first pass may be referred to as a logical deduction pass that evaluates a state or status of a forward flow vector or a backward flow vector, which may be presented by:

∀x∀y(Fₐ(x,y)==Invalid AND(F_{b}(x,y))==valid)→(A(x,y) pixel gets occluded in Frame B)

∀x∀y(F_{b}(x,y)==Invalid AND(Fₐ(x,y))==valid)→(B(x,y) pixel gets occluded in Frame A)

As such, if a pixel at location (x,y) has an invalid flow vector in frame A, but the corresponding (x,y) pixel in frame B has a valid flow vector, then the pixel of frame A at (x,y) is assumed to be occluded in frame B. Additionally, if a pixel at location (x,y) has an invalid flow vector in frame B, but the corresponding (x,y) pixel in frame A has a valid flow vector, than that pixel of frame B(x,y) is assumed to be occluded in frame A.

The initial pass may identify regions of the image where occluded pixels are grouped or otherwise present (e.g., not necessarily grouped). However, as noted above, various embodiments may be executed using noisy input optical flow data. This noisy data may lead to wrongly identified pixels. Accordingly, a filter may be used on the output(s) of the first pass provided above. For example, a median filter may be used. In at least one embodiment, a 5×5 median filter is used. Because inaccurate flow vectors due to occlusion tend to spatially congregate, the filter may be useful in detecting inaccurate flow vectors that are sparsely distributed in space, which may be a result of noise (e.g., noise in the input optical flow data or noise in a consistency check algorithm, among other sources). This filter may then be used to remove incorrect occlusion labels. Accordingly, the two-pass approach may be used to identify pixels that are actually occluded despite the inherent limitations provided by an optical flow engine output and/or a flow vector sanity algorithm.

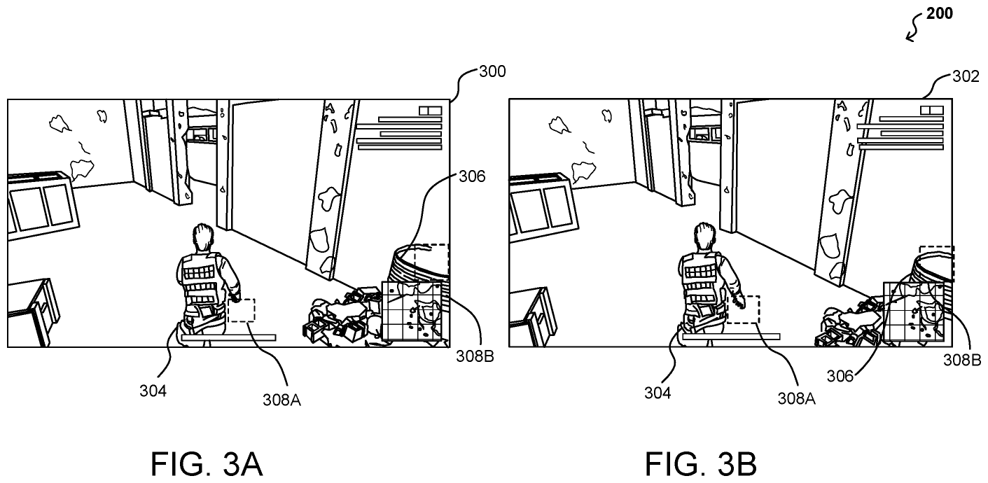

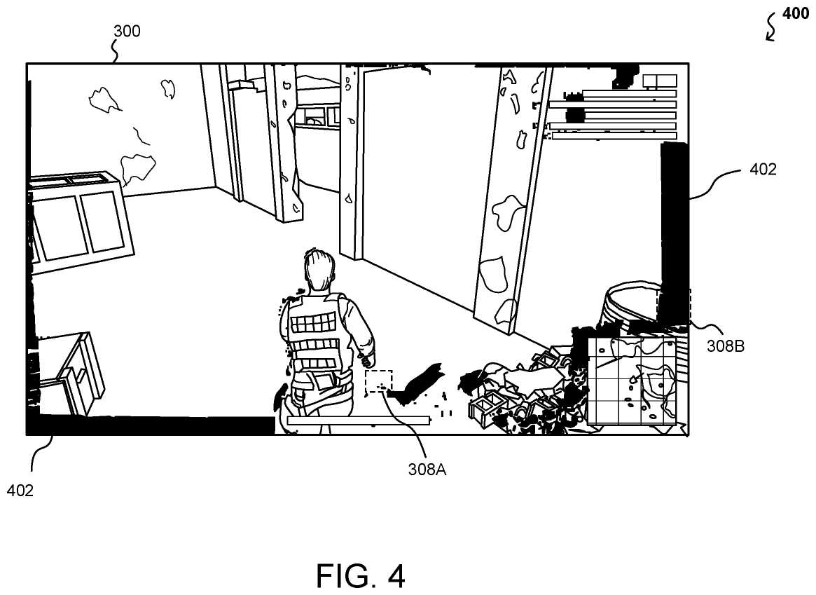

FIGS. 3A and 3B are example representations of input images 300, 302 that are temporally spaced from one another. For example, input image 300 may correspond to frame A describe above and input image 302 may correspond to frame B describe above. As shown in this example, an object 304, corresponding to a digital representation of a person is positioned within image 300 at a first position along with a second object 306 in the corner. When compared to image 302, a portion of the object 304 has moved, for example the arm, and also, movement of the frame itself (e.g., due to zooming inward in the Z-direction) has changed the visible area of the second object 306. Accordingly, a region 308A (which may be formed by one or more pixels) in the image 300 is now occupied by different objects in the region 308A in the image 302 due to the movement of the object's arm. Similarly, less of the object 306 is visible in the region 308B in the image 302 when compared to the image 300. As such, one or more of these pixels may be considered to be occluded between the image 300 and the image 302.

Various embodiments of the present disclosure may receive these input images 300, 302 and use generated flow vectors in order to determine which regions are occluded, for example, due to movement of various objects and/or movement or changes in the visible area of the frame. For example, FIG. 4 illustrates a representation 400 of the image 300 after the evaluation described herein (e.g., the forward-backward check, the logical deduction, the filtering, etc.) illustrating which regions will be occluded in the image 302. As shown, certain regions 402 are identified as including occluded pixels. These pixels may be occluded due to movement of foreground objects, changes in the view area of the frame (e.g., panning or zooming), or the like. The regions 402 may overlap, at least partially, with the regions 308A, 308B from FIGS. 3A and 3B, illustrating that movement or panning was identified using the methods herein to determine regions of occluded pixels.

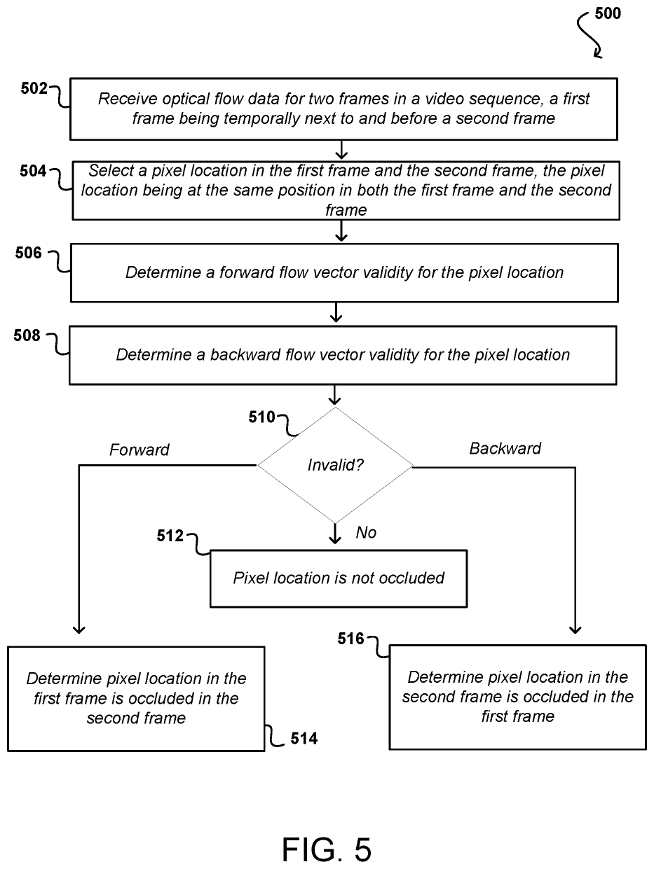

FIG. 5 illustrates an example process 500 for determining occluded pixels between two frames of a video sequence. It should be understood that for this and other processes presented herein that there can be additional, fewer, or alternative steps performed in similar or alternative order, or at least partially in parallel, within the scope of various embodiments unless otherwise specifically stated. In this example, optical flow data is received for at least two frames in a video sequence 502. The frames are temporally next to one another, but it should be appreciated that the frames are not necessarily sequential frames within the video sequence. That is, there may be intermediate frames between the two frames being analyzed. The frames may be identified as a first frame, at an earlier time, and a second frame, at a later time.

A pixel location in the first frame and the second frame may be selected 504. In various embodiments, the pixel location is the same in the first and second frames and may be represented as (x,y). In at least one embodiment, embodiments may be directed toward evaluation of each pixel of the image. However, it should be appreciated that only specified pixels may be selected for evaluation, where the selection may be based on one or more factors of the images being analyzed, previous processing steps, or the like.

Forward and backward flow vectors may be determined for the pixel location. For example, one or more optical flow engines may be used to generate the respective flow vectors, where the flow vectors may be referred to as forward flow vectors for movement from the first frame to the second frame and as backward flow vectors for movement from the second frame to the first frame. The forward flow vector validity and the backward flow vector validity may be determined 506, 508. Validity may be based, at least in part, on a forward-backward check. As noted above, while the forward-backward check may be helpful in determining validity, such a process may be insufficient to determine whether invalidity is due to occlusion.

A flow vector status may be evaluated, where it is determined whether or not a flow vector (e.g., the forward flow vector and the backward flow vector for a specific pixel location) is invalid 510. If not, the pixel location is determined as not being occluded 512. If the forward flow vector is invalid while the backward flow vector is valid, then the pixel location in the first frame is determined to be occluded in the second frame 514. If the forward flow vector is valid while the backward flow vector is invalid, then the pixel location in the second frame is determined to be occluded in the first frame 516. This process may be repeated for one or more pixels of the images to determine different occluded regions within the images. It should be appreciated that additional processing may also be used, as noted above.

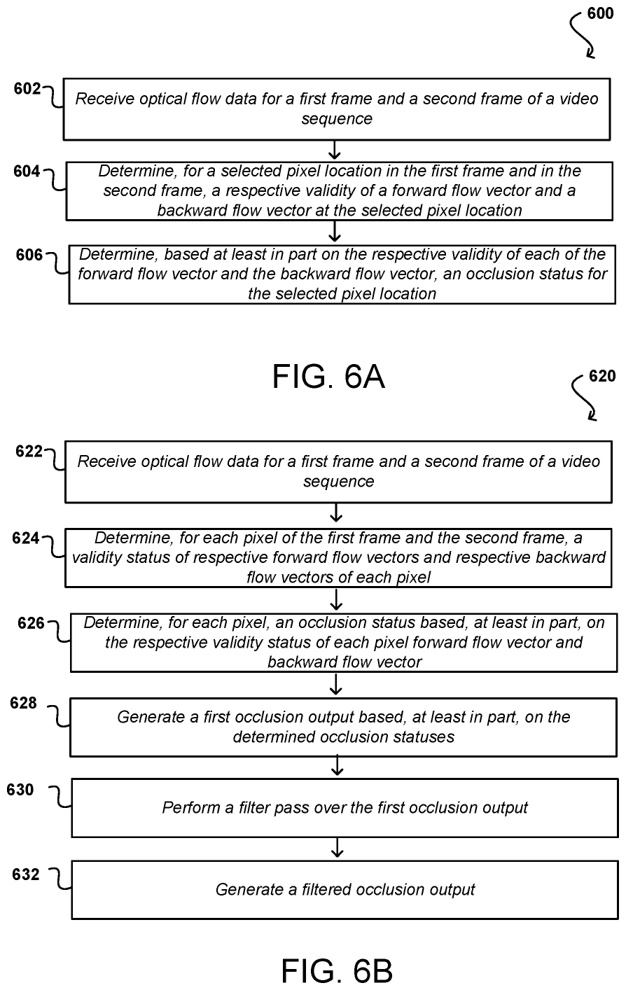

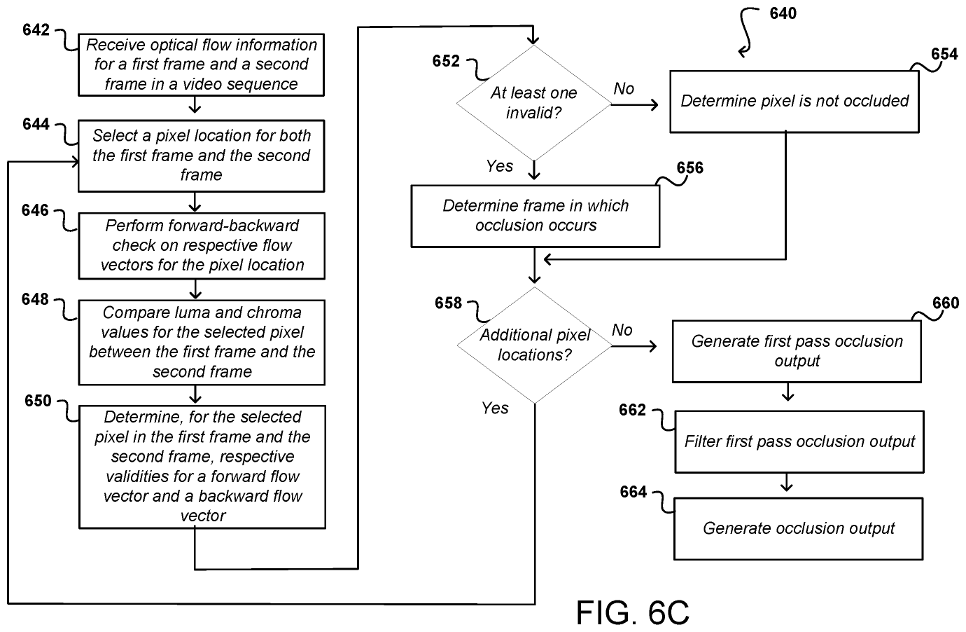

FIG. 6A illustrates an example process 600 for determining occluded pixels between two frames of a video sequence. In this example, optical flow data for a first frame and a second frame in a video sequence is received 602. The optical flow data may include, at least in part, optical flow vectors (e.g., motion vectors) for one or more pixels forming the first and second frames. In various embodiments, the optical flow vectors may be sanitized, which may include performing one or more methods, such as a forward-backward check, to detect inconsistencies with flow vectors. In at least one embodiment, the entire first and second frames are analyzed, but it should be appreciated that embodiments may be directed toward only specific pixels within a frame. For example, one or more regions of the frame may have a known occluded area, for example due to a logo, a heads up display, or the like. As a result, it may be known that these regions will remain consistent or substantially consistent and will occlude any other pixels that move into these regions. Accordingly, certain regions may be removed from the analysis in order to conserve processing resources.

A pixel location may be selected within the first frame and the second frame, with the pixel location being generally designated as (x,y) and being substantially the same in each frame, such that the location in the first frame may be designated as A(x,y) and the location in the second frame may be designated as B(x,y). For this selected pixel location, respective validities for a forward flow vector and a backward flow vector may be determined 604. For example, as noted above, validity may be based, at least in part, on a forward-backward check of the pixels, where a flow vector may be considered invalid if it fails the check. Based at least in part on the validities for the forward and backward flow vectors, an occlusion status for a pixel may be determined 606. For example, for a given location, with a valid flow vector in a forward direction and an invalid flow vector in a backward direction, then the pixel in the second frame may be deemed to be occluded in the first frame. Additionally, as an example, a pixel that had an invalid flow vector in the forward direction and a valid flow vector in the backward direction may be deemed to be occluded in the second frame. This information may then be aggregated over the frame and/or over a selected set of pixels to identify one or more occluded regions within a frame of the first or second frames. Further processing may then use the information regarding the one or more occluded regions, including object detection, game engine rendering, motion tracking, and the like.

FIG. 6B illustrates an example process 620 for determining occluded pixels between two frames of a video sequence. As previous indicated, two images within the sequence are provided by way of example and additional images may also be evaluated. Furthermore, the frames may not be sequential frames (e.g., there may be intervening frames between the two frames). Moreover, it should be appreciated that such processing may not be performed on each frame in a video sequence and may be limited or otherwise selected for use with only particular frames within the sequence. In this example, optical flow data for a first frame and a second frame of a video sequence is received 622. The optical flow data may include, at least in part, motion vectors for individual pixels within the respective frames, where the motion vectors may include forward motion vectors (e.g., from the first frame to the second frame) and backward motion vectors (e.g., from the second frame to the first frame).

In various embodiments, each pixel within the frames may be analyzed; however, as noted, other embodiments may limit which pixels are analyzed. For the example of FIG. 6B, a respective validity status for a forward motion vector and a backward motion vector for each pixel is determined 624. Validity may be based, at least in part, on one or more processing steps, such as a forward-backward check to detect consistency between motion vectors. For each of the pixels, an occlusion status may be determined based, at least in part, on the respective validity for the forward and backward motion vectors 626. The occlusion status may be based on an evaluation of the validities of the motion vectors, where a pixel with only one valid motion vector (e.g., one of the forward or backward motion vector) may be considered occluded. Additionally, the identification of the invalid flow vector may determine where occlusion occurs, as described above. This process may be repeated over each of the pixels within the frames to generate a first occlusion output 628. The first occlusion output may correspond to information related to an occlusion status for each of the pixels within the frames. Additionally, an overlay may be provided to visualize the occlusion status, but it should be appreciated that this overlay would be provided for a user to view the occlusion status and may not be the information processed by one or more downstream engines to address the occluded pixels.

As noted, various embodiments may use noisy motion vectors, and this noise may lead to misidentification of occluded pixels. A filter pass may be performed over the first occlusion output 630. For example, a median filter, such as a 5×5 median filter, may be used to identify potentially misidentified pixels. A filtered occlusion output may then be generated 632 for use with downstream processing engines. Accordingly, occluded regions may be identified using a lightweight, less processor-intensive method that may also be performed with noisy optical flow data, thereby providing improvements over existing methods that use either highly accurate flow information or processor-intensive neural network approaches.

FIG. 6C illustrates an example process 640 for determining occluded pixels between two frames of a video sequence to generate an occlusion output. In this example, optical flow information for a first frame and a second frame of a video sequence is received 642. The optical flow data may be generated using a variety of techniques, and in certain embodiments, may be considered to be noisy optical flow data. A pixel location for both the first frame and the second frame is selected 644. The pixel location may correspond to an individual pixel location in both the first frame and the second frame that correspond to one another. For example, a top-left most pixel may be pixel location (0,0), indicating a 0 x-position and a 0 y-position. A forward-backward check may be performed on the flow vectors for the selected pixel location 646. For example, the forward-backward check may analyze both a forward flow vector (e.g., from the first frame to the second frame) and a backward flow vector (e.g., from the second frame to the first frame) to evaluate inconsistencies. Additionally, embodiments may compare luma and chroma values for the selected pixels between the first frame and the second frame 648. Comparisons of luma and chroma may reduce a likelihood of mischaracterization of the pixels and/or flow vectors. For example, for a pixel that moves from a shadow region to a non-shadow region, the luma component may lead to invalidation of the associated flow vector, even though the flow vector is valid. Adding the chroma comparison may avoid this problem. For example, if the source pixel and the destination pixel (e.g., A(x,y) and B(x,y)) has a wide difference in luma, but chroma values within a threshold, the flow vector may be considered valid.

Various embodiments determine, for the selected pixel, respective validities for the forward flow vector and the backward flow vector 650. These validities may then be used to determine an occlusion status for the selected pixel. For example, the validity status of the flow vectors may be evaluated to determine whether at least one is invalid 652. If not, then a determination may be made that the pixel is not occluded 654. If so, then the frame where occlusion occurs is determined 656. For example, an invalid forward flow vector and a valid backward flow vector may indicate the selected pixel in the first frame becomes occluded in the second frame. Similarly, a valid forward flow vector and an invalid backward flow vector may indicate the selected pixel is occluded in the first frame. This may enable determination of the occlusion status of the selected pixel with respect to each frame. It may then be determined whether additional pixels are available for processing 658. In certain embodiments, each pixel in each frame is evaluated. In other embodiments, only certain pixels are evaluated. If there are no additional pixels for evaluation, a first pass occlusion output is generated 660. This first pass may be filtered 662, where filtering may be used to remove incorrect occlusion labels. An occlusion output may then be generated 664, which may be provided to one or more downstream processes or pipelines. In this manner, occluded regions within images may be identified based on optical flow information.

### Data Center

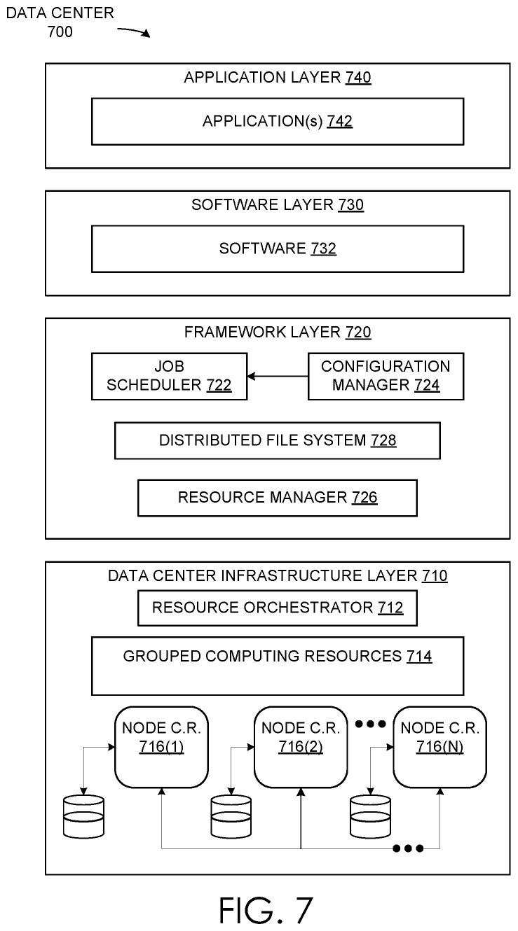

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used for optical flow detection.

### Computer Systems

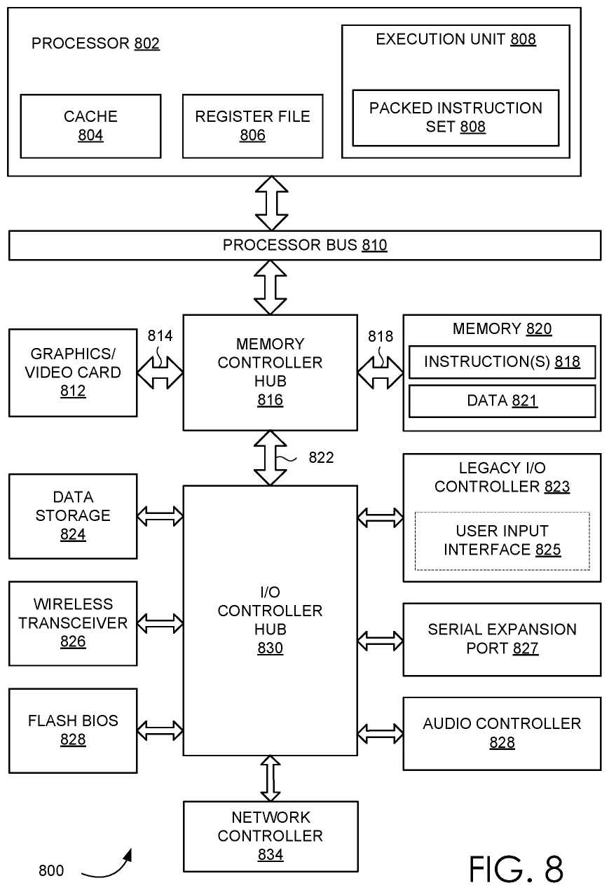

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), edge computing devices, set-top boxes, network hubs, wide area network (“WAN”) switches, or any other system that may perform one or more instructions in accordance with at least one embodiment.

Embodiments of the systems and methods described herein may be used for a variety of purposes, by way of example and without limitation, for machine control, machine locomotion, machine driving, synthetic data generation, digital twinning, model training, perception, augmented reality, virtual reality, mixed reality, robotics, security and surveillance, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be incorporated or integrated in a variety of different systems such as automotive systems (e.g., a human-machine interface for an autonomous or semi-autonomous machine), systems implemented using a robot, aerial systems, medial systems, boating systems, smart area monitoring systems, systems for performing deep learning operations, systems for performing simulation and digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Such components can be used for optical flow detection.

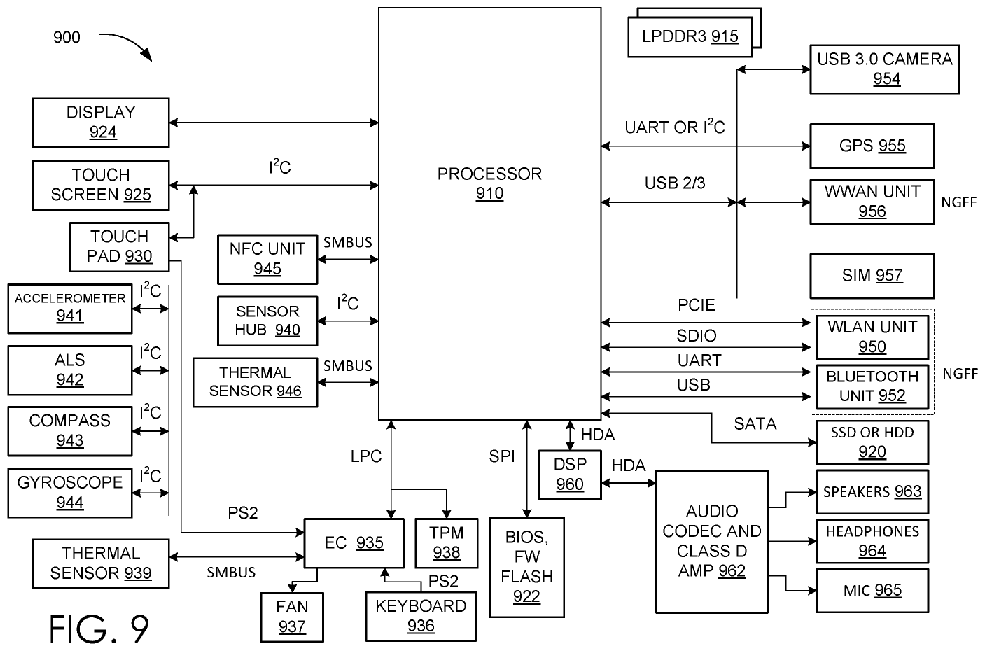

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 946, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Such components can be used for optical flow detection.

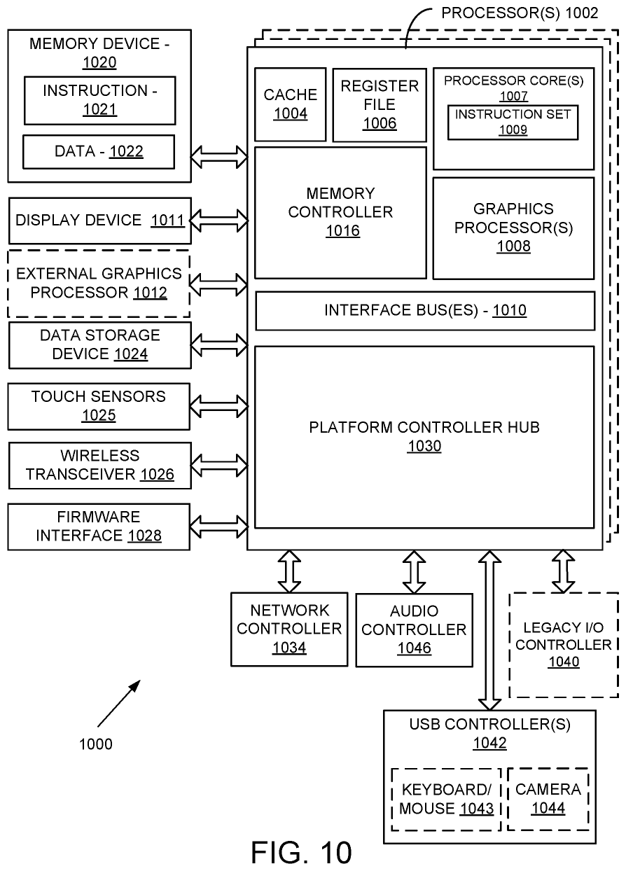

FIG. 10 is a block diagram of a processing system, according to at least one embodiment. In at least one embodiment, system 1000 includes one or more processors 1002 and one or more graphics processors 1008, and may be a single processor desktop system, a multiprocessor workstation system, or a server system or datacenter having a large number of collectively or separably managed processors 1002 or processor cores 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a cloud computing host platform, a virtualized computing platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, edge device, Internet of Things (“IoT”) device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor cores 1007 may each process a different instruction set 1009, which may include instructions to facilitate emulation of other instruction sets. In at least one embodiment, processor core 1007 may also include other processing devices, such a Digital Signal Processor (DSP).

In at least one embodiment, processor 1002 includes cache memory 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level-3 (L3) cache or Last Level Cache (LLC)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in system 1000. In at least one embodiment, interface bus 1010, in one embodiment, can be a processor bus, such as a version of a Direct Media Interface (DMI) bus. In at least one embodiment, interface 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Such components can be used for optical flow detection.

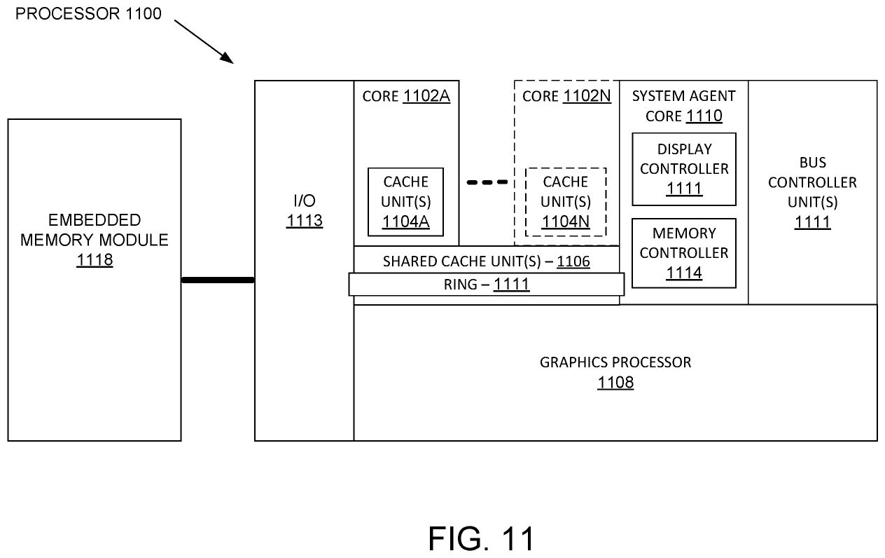

FIG. 11 is a block diagram of a processor 1100 having one or more processor cores 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor cores 1102A-1102N includes one or more internal cache units 1104A-1104N. In at least one embodiment, each processor core also has access to one or more shared cached units 1106.

In at least one embodiment, internal cache units 1104A-1104N and shared cache units 1106 represent a cache memory hierarchy within processor 1100. In at least one embodiment, cache memory units 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1106 and 1104A-1104N.

In at least one embodiment, processor 1100 may also include a set of one or more bus controller units 1116 and a system agent core 1110. In at least one embodiment, one or more bus controller units 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor cores 1102A-1102N include support for simultaneous multi-threading. In at least one embodiment, system agent core 1110 includes components for coordinating and operating cores 1102A-1102N during multi-threaded processing. In at least one embodiment, system agent core 1110 may additionally include a power control unit (PCU), which includes logic and components to regulate one or more power states of processor cores 1102A-1102N and graphics processor 1108.

In at least one embodiment, processor 1100 additionally includes graphics processor 1108 to execute graphics processing operations. In at least one embodiment, graphics processor 1108 couples with shared cache units 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring interconnect 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor cores 1102A-1102N and graphics processor 1108 use embedded memory modules 1118 as a shared Last Level Cache.

In at least one embodiment, processor cores 1102A-1102N are homogenous cores executing a common instruction set architecture. In at least one embodiment, processor cores 1102A-1102N are heterogeneous in terms of instruction set architecture (ISA), where one or more of processor cores 1102A-1102N execute a common instruction set, while one or more other cores of processor cores 1102A-1102N executes a subset of a common instruction set or a different instruction set. In at least one embodiment, processor cores 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Such components can be used for optical flow detection.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) and/or a data processing unit (“DPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be any processor capable of general purpose processing such as a CPU, GPU, or DPU. As non-limiting examples, “processor” may be any microcontroller or dedicated processing unit such as a DSP, image signal processor (“ISP”), arithmetic logic unit (“ALU”), vision processing unit (“VPU”), tree traversal unit (“TTU”), ray tracing core, tensor tracing core, tensor processing unit (“TPU”), embedded control unit (“ECU”), and the like. As non-limiting examples, “processor” may be a hardware accelerator, such as a PVA (programmable vision accelerator), DLA (deep learning accelerator), etc. As non-limiting examples, “processor” may also include one or more virtual instances of a CPU, GPU, etc., hosted on an underlying hardware component executing one or more virtual machines. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processing units to:
receive a first image and a second image of a sequence of images;
determine a first optical flow vector corresponding to a pixel location in the first image;
determine a second optical flow vector corresponding to the pixel location in the second image; and
determine, based at least in part on respective validities of the first optical flow vector and the second optical flow vector, an occlusion status for the pixel location in the first image and in the second image.

2. The system of claim 1, wherein the one or more processing units are further to filter at least one of a first image occlusion status or a second image occlusion status.

3. The system of claim 2, wherein the filter is a median filter.

4. The system of claim 1, wherein the first optical flow vector is a forward flow vector and the second optical flow vector is a backward flow vector.

5. The system of claim 4, wherein the one or more processing units are further to determine that the pixel location in the first frame is occluded in the second frame when the forward flow vector is invalid for the pixel location and the backward flow vector is valid for the pixel location.

6. The system of claim 4, wherein the one or more processing units are further to determine that the pixel location in the second frame is occluded in the first frame when the forward flow vector is valid for the pixel location and the backward flow vector is invalid for the pixel location.

7. The system of claim 1, wherein the one or more processing units are further to determine respective validities based at least on a forward-backward check.

8. The system of claim 1, wherein the system is comprised in at least one of:
a human-machine interface system of an autonomous or semi-autonomous machine;
a human-machine interface system of a gaming machine;
a system for performing conversational AI operations;
a system for performing simulation operations;
a system for performing digital twin operations;
a system for performing deep learning operations;
a system for generating or presenting virtual reality (VR) content;
a system for generating or presenting augmented reality (AR) content;
a system for generating or presenting mixed reality (MR) content;
a system for performing video playback;
a system for performing rendering operations;
a system for performing three-dimensional rendering operations;
a system implemented using an edge device;
a system implemented using a robot;
a system incorporating one or more virtual machines (VMs);
a system implemented at least partially in a data center; or
a system implemented at least partially using cloud computing resources.

9. A method, comprising:
generating optical flow data for a pixel location in a pair of images;
determining a first validity of a forward flow vector for the pixel location in a first image of the pair of images;
determining a second validity of a backward flow vector for the same pixel location in a second image of the pair of images, the second image being later in time than the first image; and
determining the pixel location is occluded in one of the first image or the second image based, at least in part, on the first validity and the second validity.

10. The method of claim 9, further comprising performing a forward-backward check on the forward flow vector and the backward flow vector.

11. The method of claim 9, further comprising determining the pixel location in the first image is occluded in the second image based at least on a determination that the forward flow vector is invalid and the backward flow vector is valid.

12. The method of claim 9, further comprising determining the pixel location in the second image is occluded in the first image based at least on a determination that the forward flow vector is valid and the backward flow vector is invalid.

13. The method of claim 9, further comprising:
determining a difference between a first luma value for the pixel location in the first image and a second luma value for the pixel location in the second image exceeds a luma threshold;
determining a difference between a first chroma value for the pixel location in the first image and a second chroma for the pixel location in the second image is within a chroma threshold; and
determining at least one of the forward flow vector or the backward flow vector is valid.

14. The method of claim 13, further comprising generating an occlusion output identifying an occlusion status of the pixel location in at least one of the first image or the second image.

15. The method of claim 14, wherein the optical flow data is noisy optical flow data.

16. A method, comprising:
receiving a first frame of a video sequence;
receiving a second frame of the video sequence;
determining, for a pixel in the first frame, a respective forward motion vector from the first frame to the second frame;
determining, for the pixel in the second frame, a respective backward motion vector from the second frame to the first frame;
determining a first validity of the forward motion vector;
determining a second validity for backward motion vector; and
determining, based at least on the first validity and the second validity, a first occlusion status of the pixel in the first frame and a second occlusion status of the pixel in the second frame.

17. The method of claim 16, further comprising:
determining the forward motion vector for the pixel is invalid;
determining the backward motion vector the pixel is valid; and
determining the pixel in first frame is occluded in second frame.

18. The method of claim 16, further comprising:
determining the backward motion vector for the pixel is invalid;
determining the forward motion vector the pixel is valid; and
determining the pixel in second frame is occluded in first frame.

19. The method of claim 16, wherein determining the first validity and the second validity includes at least a forward-backward check.

20. The method of claim 16, further comprising providing the occlusion status to a downstream game engine.
